(19) United States
(12) Patent Application Publication
(10) Pub. No.: US 2012/0223591 A1
(43) Pub. Date: Sep. 6, 2012

(54) OVERVOLTAGE PROTECTION CIRCUIT, POWER TRANSMISSION DEVICE INCLUDING THE SAME, AND CONTROL METHOD THEREOF

(75) Inventors: Sang Hoon Cheon, Daejeon (KR); Yong Hae Kim, Daejeon (KR); Seung Youl Kang, Daejeon (KR); Myung Lae Lee, Daejeon (KR); Je Hoon Yun, Daejeon (KR)

(73) Assignee: ELECTRONICS AND TELECOMMUNICATIONS RESEARCH INSTITUTE, Daejeon (KR)

(21) Appl. No.: 13/366,389

(22) Filed: Feb. 6, 2012

(30) Foreign Application Priority Data
Mar. 2, 2011 (KR) 10-2011-0018574
May 27, 2011 (KR) 10-2011-0050767

(51) Int. Cl. H02J 17/00

(52) U.S. Cl. 307/104

(57) ABSTRACT

Provided is a power transmission device including a transmission unit and a reception unit. The reception unit includes an overvoltage protection circuit and provides a feedback signal to the transmission unit. The transmission unit controls intensity of power wirelessly transmitted to the reception unit with reference to the feedback signal to control power consumption of the overvoltage protection circuit. The overvoltage protection circuit includes a detection unit and a current control unit. The detection unit detects an input voltage and a first current to generate a control signal. The current control unit controls a second current with reference to the control signal. Herein, the second current is controlled so that a ratio of the input voltage to a sum of the first and second currents is kept constant.

### CROSS-REFERENCE TO RELATED APPLICATIONS

This U.S. non-provisional patent application claims priority under 35 U.S.C. §119 of Korean Patent Application Nos. 10-2011-0018574, filed on Mar. 2, 2011, and 10-2011-0050767, filed on May 27, 2011, the entire contents of which are hereby incorporated by reference.

### BACKGROUND OF THE INVENTION

The present invention disclosed herein relates to an overvoltage protection circuit, a power transmission device including the same, and a control method thereof.

As a wireless communication technology develops, more kinds of electronic devices wirelessly transmit various information and signals. Further, researches are being conducted to develop methods for wirelessly transmitting power needed for driving electronic devices. As examples of the methods for wirelessly transmitting power, there are techniques using an electromagnetic induction phenomenon and a magnetic resonance phenomenon.

A power transmission device generally includes a resonant circuit. Sometimes, due to resonance effects and external influences, a very large overvoltage may be loaded on the power transmission device. The overvoltage may damage an internal circuit and an electronic device connected thereto. Therefore, an overvoltage protection circuit is needed for protecting a circuit from an overvoltage. However, the overvoltage protection circuit itself consumes power. Moreover, due to the overvoltage protection circuit, an impedance mismatch between a transmitting unit and a receiving unit may occur. Consequently, transmission efficiency of the power transmission device is degraded.

### SUMMARY OF THE INVENTION

The present invention provides a low power consumption overvoltage protection circuit, a power transmission device including the same, and a control method thereof.

The present invention also provides an overvoltage protection circuit with improved impedance matching characteristics, a power transmission device including the same, and a control method thereof.

The present invention also provides an overvoltage protection circuit for protecting an internal circuit from an overvoltage, a power transmission device including the same, and a control method thereof.

Embodiments of the present invention provide overvoltage protection circuits including a detection unit configured to detect a first current flowing from an input terminal to an output terminal and an input voltage applied to the input terminal to generate a control signal; and a current control unit configured to control a second current flowing from the input terminal to a ground in response to the control signal so that a ratio of the input voltage to an input current inputted through the input terminal is kept constant.

In some embodiments, the input current may be a sum of the first and second currents.

In other embodiments, the current control unit may include a variable resistor which connects the input terminal and the ground.

In other embodiments of the present invention, power transmission devices include a reception unit including an overvoltage protection circuit; and a transmission unit configured to wirelessly transmit power to the reception unit, wherein the transmission unit controls power consumption of the overvoltage protection circuit by controlling intensity of the power transmitted with reference to a feedback signal provided from the reception unit.

In some embodiments, the overvoltage protection circuit may include a detection unit configured to detect a first current flowing from an input terminal to an output terminal and an input voltage applied to the input terminal to generate a control signal; and a current control unit configured to control a second current flowing from the input terminal to a ground in response to the control signal so that a ratio of the input voltage to an input current inputted through the input terminal is kept constant.

In other embodiments, the input current may be a sum of the first and second currents.

In still other embodiments, the reception unit may include a DC converter configured to transform power outputted from the overvoltage protection circuit and provide the transformed power to a load.

In even other embodiments, a feedback control unit configured to receive a detection signal from the overvoltage protection circuit, and provide the detection signal as the feedback signal may be included.

In yet other embodiments, the detection signal may include a signal which indicates a value of the second current.

In further embodiments, the overvoltage protection circuit may further include a switch unit configured to electrically cut of the DC converter from the overvoltage protection circuit.

In still further embodiments, the switch unit may include a switch located between the detection unit and the DC converter; and a switch controller configured to control opening and closing of the switch.

In even further embodiments, the reception unit may further include a rectifying unit which is located in front of the overvoltage protection circuit and rectifies an alternating current power to a direct current power.

In yet further embodiments, the reception unit may further include a matching circuit which is located in front of the rectifying unit and matches impedances between the transmission unit and the reception unit.

In other embodiments of the present invention, methods for controlling a power transmission device which includes a reception unit provided with an overvoltage protection circuit include detecting a first current which flows from an input terminal of the overvoltage protection circuit to an output terminal thereof; detecting an input voltage applied to the input terminal; and controlling a second current which flows from the input terminal to a ground with reference to the first current and the input voltage so that a ratio of the input voltage to an input current inputted through the input terminal is kept constant.

In some embodiments, the methods may further include providing a value of the input voltage or second current as a feedback signal to a transmission unit; and controlling intensity of power which is wirelessly transmitted from the transmission unit to the reception unit with reference to the feedback signal.

In other embodiments, the controlling of the intensity of the power may include decreasing or increasing the intensity of the power transmitted if the second current is larger than or smaller than a reference current.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a block diagram illustrating a power transmission device according to an embodiment of the present invention;

FIG. 2 is a block diagram exemplarily illustrating an overvoltage protection circuit illustrated in FIG. 1;

FIG. 3 is a circuit diagram illustrating a current distribution unit illustrated in FIG. 2 under the assumption that the current distribution unit is a fixed resistor;

FIG. 4 is a block diagram exemplarily illustrating a current distribution unit according to the present invention;

FIG. 5 is a block diagram exemplarily illustrating a switch unit illustrated in FIG. 2;

FIG. 6 is a diagram exemplarily illustrating a DC/DC converter illustrated in FIG. 1;

FIG. 7 is a diagram illustrating a power transmission device in which power consumption of an overvoltage protection circuit is reduced, according to an embodiment;

FIG. 8 is a diagram exemplarily illustrating a matching circuit of FIG. 1;

FIG. 9 is a block diagram exemplarily illustrating a rectifying unit illustrated in FIG. 1;

FIG. 10A is a circuit diagram exemplarily illustrating a rectifying circuit illustrated in FIG. 9;

FIG. 10B illustrates waveforms of an inputted alternating current voltage V_{A} and an outputted direct current voltage V_{B} of FIG. 10A;

FIG. 11 is a diagram exemplarily illustrating a noise filter illustrated in FIG. 9;

FIG. 12A is a circuit diagram exemplarily illustrating a smoothing circuit illustrated in FIG. 9;

FIG. 12B illustrates waveforms of an input voltage V₁ (shown in dotted line) and an output voltage V_{O} (shown in continuous line) illustrated in FIG. 12A; and

FIG. 13 is a flowchart illustrating a control method of a power transmission device according to an embodiment of the present invention.

### DETAILED DESCRIPTION OF PREFERRED EMBODIMENTS

The above-described background and the following detailed description are provided just for exemplarily describing the present invention. Therefore, the present invention may be embodied in different forms and should not be constructed as limited to the embodiments set forth herein. Rather, these embodiments are provided so that this disclosure will be thorough and complete, and will fully convey the scope of the present invention to those skilled in the art.

In the specification, when it is stated that a certain unit includes some elements, the unit may further include other elements. Also, the embodiments exemplified and described in this specification include complementary embodiments thereof. Hereinafter, the embodiments of the present invention will be described in detail with reference to the accompanying drawings.

For wirelessly transmitting power, an electromagnetic induction method is typically used. In detail, the electromagnetic induction-type wireless power transmission method is used for electric toothbrushes. However, according to the electromagnetic induction-type wireless power transmission method, a decreasing rate of transmission efficiency is too large. Moreover, an eddy current may cause generation of heat.

According to a magnetic resonance-type wireless power transmission method, on which researches have recently been conducted, high transmission efficiency may be obtained even at a far distance in comparison with the electromagnetic induction method. The magnetic resonance-type wireless power transmission method is based on evanescent wave coupling. The evanescent wave coupling means a phenomenon in which an electromagnetic wave moves from one medium to another medium through a near electromagnetic field when the two media resonate at the same frequency. Therefore, according to the magnetic resonance-type wireless power transmission method, energy is transferred only when resonant frequencies of two media are the same, and non-transferred energy is reabsorbed to an electromagnetic field.

Meanwhile, although the magnetic resonance-type wireless power transmission method makes it possible to wirelessly transmit power to a long distance away in comparison with the typical electromagnetic induction-type wireless power transmission method, transmission efficiency is still degraded in proportion to a distance. Further, when an electronic device which receives power is not fixed, an optimal impedance matching point may not be determined.

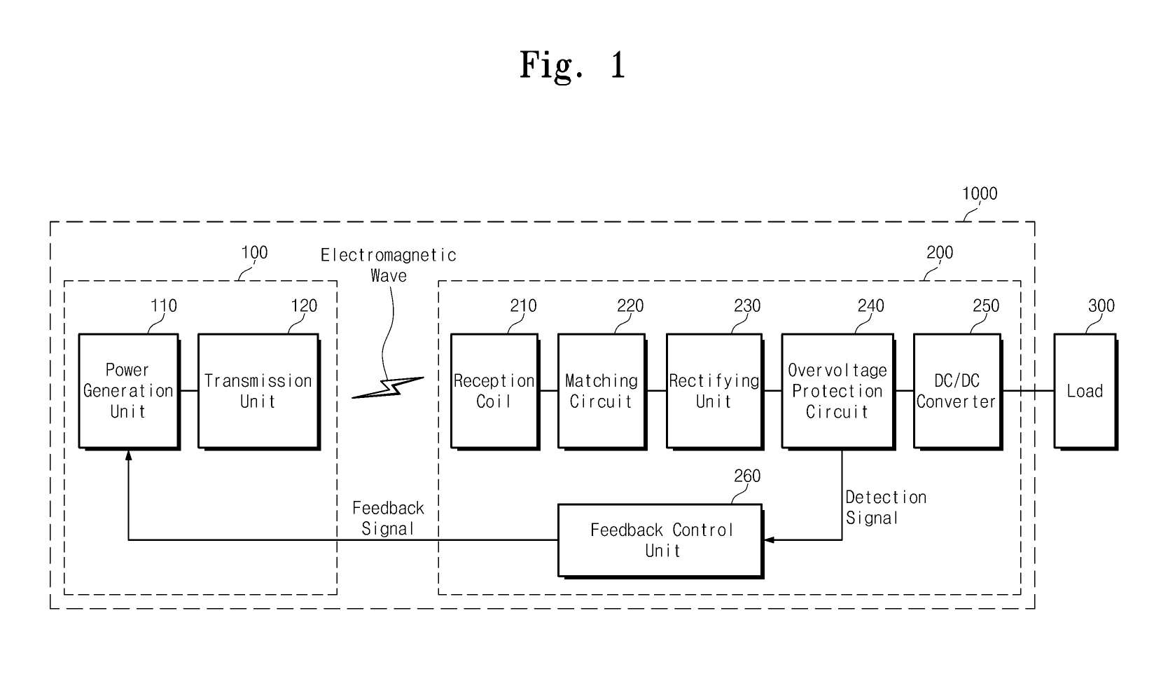

FIG. 1 is a block diagram exemplarily illustrating a power transmission device according to an embodiment of the present invention. Referring to FIG. 1, a power transmission device 1000 includes a transmission unit 100 and a reception unit 200.

The transmission unit 100 includes a power generation unit 110 for generating power and a transmission coil 120. The reception unit 200 includes a reception coil 210, a matching circuit 220, a rectifying unit 230, an overvoltage protection circuit 240, a DC/DC converter (hereinafter, referred to as a DC converter) 250, and a feedback control unit 260. Power transmission between the transmission unit 100 and the reception unit 200 is performed by sending and receiving an electromagnetic wave.

The transmission coil 120 transmits power generated by the power generation unit 110 in the form of an electromagnetic wave. The reception coil 210 receives the electromagnetic wave transmitted from the transmission coil 120 and converts the received electromagnetic wave into power. The interconversion between the electromagnetic wave and power is performed due to an electromagnetic induction phenomenon or a magnetic resonance phenomenon.

The transmission coil 120 and the reception coil 210 may be differently configured according to a wireless power transmission method. For instance, for the electromagnetic induction-type wireless power transmission method, each of the transmission coil 120 and the reception coil 210 may be configured with a single coil. On the contrary, for the magnetic resonance-type wireless power transmission method, each of the transmission coil 120 and the reception coil 210 may be configured with two or more coils.

Since the transmission coil 120 and the reception coil 210 are well known to those skilled in the art, detailed descriptions of the coils are omitted.

The transmission unit 100 and the reception unit 200 of the power transmission device 1000 typically include resonant circuits. Therefore, a very large overvoltage may be generated due to a resonance phenomenon. The overvoltage may also be generated due to external interference. Since the overvoltage may damage an internal circuit and a load 300 connected thereto, the reception unit 200 includes the overvoltage protection unit 240.

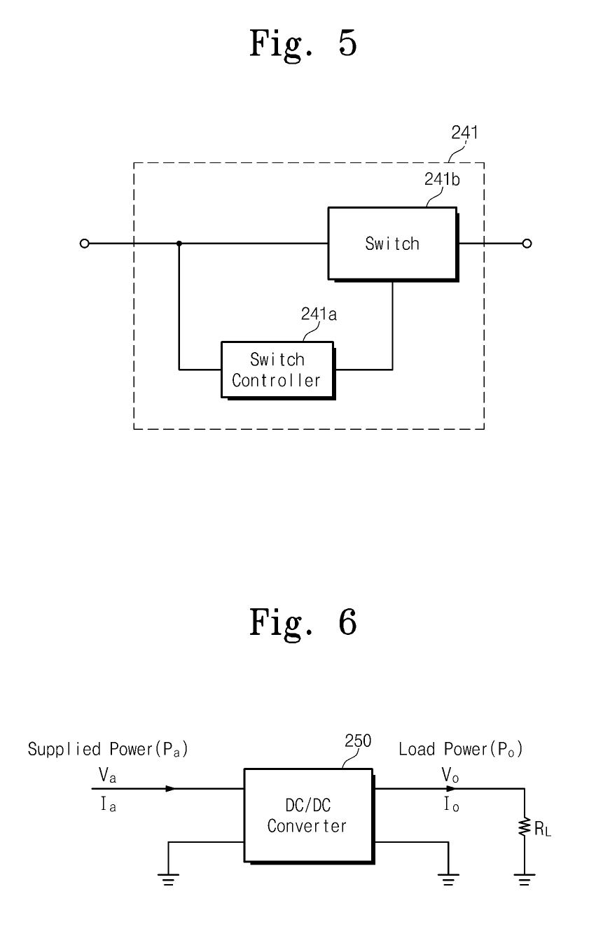

Another limitation caused by the overvoltage is that an equivalent impedance viewed from the transmission unit 100 toward the reception unit 200 (hereinafter, referred to as a receiving-end impedance) may be changed. For instance, when the overvoltage is generated, a switch 241b (refer to FIG. 5) which connects the load 300 and the reception unit 200 may be turned off to protect the load 300. This increases the receiving-end impedance. Generally, impedance is matched between the transmission unit 100 and the reception unit 200 to improve transmission efficiency. However, if the receiving-end impedance is changed, an impedance matching point is changed, and thus, impedance matching is not achieved. Since this causes reflection of power, maximum power may not be transferred, thereby degrading power transmission efficiency.

Further, a change of the load 300 may cause a larger overvoltage. Equation (1) shows how a voltage loaded on both terminals of the load 300 is changed.

$$P ( constant ) = \frac{{V}^{2}}{R} , V = \sqrt{PR} \qquad ( 1 )$$

where V is the voltage loaded on both terminals of the load 300, and R is a resistance of the load 300.

Referring to Equation (1), a voltage loaded on both terminal of a certain load increases at the rate of the square root of ratio of load change.

Particularly, if a current path which connects the reception unit 200 and the load 300 is cut off due to the overvoltage loaded on an input terminal, the receiving-end impedance increases. When supplied power is constant, a voltage is proportional to the square root of a resistance (refer to Equation (1)), and thus, the voltage increases if the resistance increases. Therefore, the receiving-end impedance increased by the overvoltage causes a larger overvoltage.

According to the present invention, an overvoltage protection circuit is proposed not only to protect the internal circuit and the load from the overvoltage but also to maintain constant receiving-end impedance so that power transmission efficiency and overvoltage protection ability are improved at the same time.

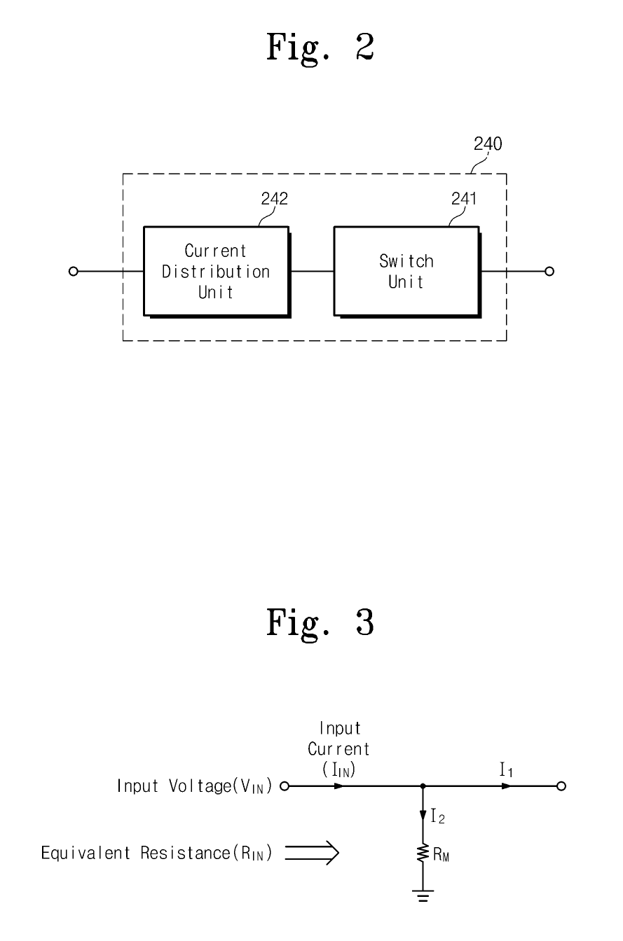

FIG. 2 is a block diagram exemplarily illustrating the overvoltage protection circuit 240 illustrated in FIG. 1. Referring to FIG. 2, the overvoltage protection circuit 240 includes a switch unit 241 and a current distribution unit 242. The switch unit 241 blocks the current path connected to the load to protect the internal circuit and the load when the overvoltage is applied. The current distribution unit 242 maintains a constant equivalent resistance viewed from an input terminal. This maintenance is carried out by adjusting a current which flows from the input terminal to a ground. Configurations and operations of the switch unit 241 and the current distribution unit 242 will be described in detail below.

FIG. 3 is a circuit diagram illustrating the current distribution unit 242 illustrated in FIG. 2 under the assumption that the current distribution unit 242 is a fixed resistor. Referring to FIG. 3, the current distribution unit 242 includes a grounding resistor R_{M} connected between the input terminal and the ground. The grounding resistor R_{M} maintains a constant current flow to the ground in response to an input voltage V_{IN}.

Although the current distribution unit 242 is simply configured with a single fixed resistor, this configuration may reduce a change of receiving-end impedance due to a variation of the load 300 and the overvoltage. In detail, in the case where the load 300 is directly connected to the current distribution 242, the equivalent resistance R_{IN} would be the same as the load 300 if the grounding resistor R_{M} does not exist. Herein, a changing rate of the equivalent resistance R_{IN} according to a change of the load 300 is 1. On the contrary, the equivalent resistance R_{IN} of the circuit including the grounding resistor R_{M} is expressed as Equation (2).

$${R}_{IN} = \frac{{R}_{M} {R}_{L}}{{R}_{M} + {R}_{L}} \qquad ( 2 )$$

Herein, the changing rate of the equivalent resistance R_{IN} according to the change of the load 300 is expresses as Equation (3).

$$\begin{matrix}changing rate ( e ) = \frac{d {R}_{IN}}{d {R}_{L}} = \frac{d}{d {R}_{L}} ( \frac{{R}_{M} \times {R}_{L}}{{R}_{M} + {R}_{L}} ) \\ = \frac{{R}_{M}^{2}}{{( {R}_{M} + {R}_{L} )}^{2}} \\ = \frac{1}{{( 1 + {R}_{L} / {R}_{M} )}^{2}}\end{matrix} \qquad ( 3 )$$

In Equations (2) and (3), R_{L}, denotes a resistance of the load 300.

Referring to Equation (3), it may be known that the changing rate (e) of the equivalent resistance R_{IN} according to the change of the load 300 is smaller than 1. That is, only with the configuration of FIG. 3, the changing of the receiving-end impedance may be reduced.

In the case of using a fixed resistor, as shown in Equation (3), when the grounding resistor R_{M} becomes smaller, the changing rate (e) of the equivalent resistance R_{IN} becomes smaller. Also, in order to make a large current rapidly flow to the ground even when the overvoltage is generated, the grounding resistor R_{M} may be small. Therefore, for improving performance, a resistance of the grounding resistor R_{M} may be smaller.

However, a small resistance of the grounding resistor R_{M} may cause several limitations. Firstly, the grounding resistor R_{M} continuously consumes power even when the overvoltage is not generated, and thus, power transmission efficiency is degraded. Particularly, since the power consumption is reversely proportional to a size of a resistor (i.e., P=V²/R), the power consumption becomes larger when the grounding resistor R_{M} becomes smaller.

Secondly, since the fixed grounding resistor R_{M} is used, the change of the equivalent resistance R_{IN} due to the change of the load may not be completely prevented. That is, referring to Equation (3), the grounding resistor R_{M} may reduce the change of the equivalent resistance R_{IN}, but cannot completely prevent the change of the equivalent resistance R_{IN}. Further, due to the fixed resistance, active responses to various situations may not be possible. Therefore, it may be considered to use the current distribution unit 242 for overcoming the limitations.

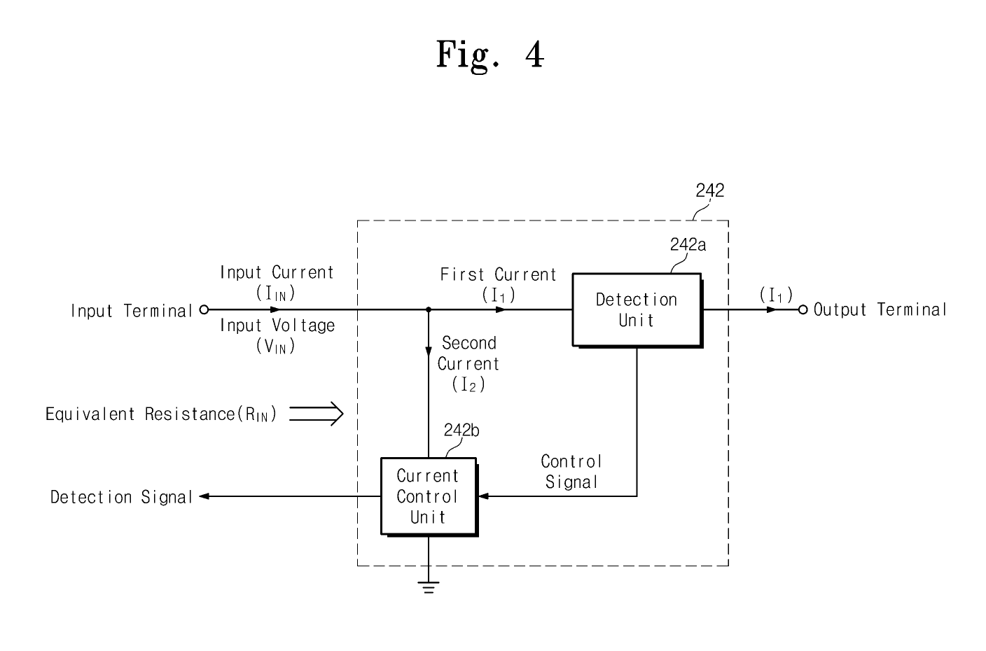

FIG. 4 is a block diagram exemplarily illustrating the current distribution unit 242 according to the present invention. Referring to FIG. 4, the current distribution unit 242 includes a detection unit 242a and a current control unit 242b. The current distribution unit 242 distributes an input current I_{IN} inputted to an input terminal to current paths. For instance, the current paths may include a path between the input terminal and an output terminal, and a path between the input terminal and the ground.

The detection unit 242a refers to a current I₁ which flows from the input terminal to the output terminal (hereinafter, referred to as a first current) and a voltage V_{IN} applied to the input terminal (hereinafter, referred to as an input voltage) to provide a corresponding control signal to the current control unit 242b.

The current control unit 242b controls intensity of a current I₂ which flows from the input terminal to the ground (hereinafter, referred to as a second current) in response to the control signal. For an embodiment, the input voltage V_{IN} may be detected by the current control unit 242b. Herein, the detection unit 242a refers to only the first current to generate the control signal, and the current control unit 242b controls the second current I₂ in response to the control signal and the input voltage V_{IN}.

The current control unit 242b controls the second current I₂ so that the input voltage V_{IN} and the first and second currents I₁ and I₂ satisfy Equation (4).

$$\frac{{V}_{IN }}{{I}_{1} + {I}_{2}} = const . \qquad ( 4 )$$

Referring to FIG. 4, a current I_{IN} inputted to the input terminal of the current distribution unit 242 (hereinafter, referred to as an input current) is equal to a sum of the first and second current I₁ and I₂. Herein, the equivalent resistance R_{IN} viewed from the input terminal is a value obtained by dividing the input voltage V_{IN} by the input current I_{IN}.

Therefore, if Equation (4) is satisfied, the equivalent resistance R_{IN} may be expressed as Equation (5).

$${R}_{IN} = \frac{{V}_{IN}}{{I}_{IN}} = \frac{{V}_{IN}}{{I}_{1} + {I}_{2}} = const . \qquad ( 5 )$$

If the second current I₂ is controlled so as to satisfy Equation (5), the equivalent resistance R_{IN} may be kept constant despite of variations of the input voltage V_{IN} and the first current. This maintenance fixes impedance viewed from the input terminal of the overvoltage protection circuit 240 toward the load 300. Therefore, even though the load 300 and the first current are changed due to the overvoltage, the receiving-end impedance is kept constant.

In detail, the detection unit 242a refers to the input voltage V_{IN} and the first current I₁ to output the control signal to the current control unit 242b. The control signal is provided as a reference signal needed for the current control unit 242b to control the second current I₂. The current control unit 242b refers to the control signal to make a current, which is needed for keeping the equivalent resistance R_{IN} constant, flow to the ground.

Referring to Equation (5), the second current I₂ may be controlled in such a manner that the second current I₂ is proportional to the input voltage V_{IN} and reversely proportional to the first current I₁. That is, the current control unit 242b controls a factor of Equation (5), i.e., the second current I₂, to thereby offset variations of other two factors, i.e., the input voltage V_{IN} and the first current I₁. If the input voltage V_{IN} increases due to the overvoltage, the second current increases. If the first current decreases because the current path to the load is cut off, the second current also increases. Accordingly, the equivalent resistance R_{IN} may be kept constant.

For an embodiment, the current control unit 242b may include a variable resistor. The variable resistor may be connected in parallel between the input terminal and the ground. The current control unit 242b refers to the control signal of FIG. 4 to adjust a resistance of the variable resistor. If the resistance of the variable resistor is changed, the intensity of the second current I₂ is also changed. Therefore, if the resistance of the variable resistor is appropriately adjusted according to the control signal, the intensity of the second current I₂ may be controlled.

According to this configuration, the current control unit 242b may variably adjust the intensity of the second current I₂. By accurately controlling the variable resistor, the equivalent resistance R_{IN} may be kept constant.

According to the above-described configuration of the present invention, the second current is controlled so that the equivalent resistance R_{IN} viewed from the input terminal of the overvoltage protection circuit 240 is kept constant, and thus, the receiving-end impedance is kept constant. As a result, impedance matching characteristics of the power transmission device 1000 are improved.

Meanwhile, the current control unit 242b provides the input voltage Y_{IN} and the second current I₂ as detection signals to the feedback control unit 260 (refer to FIG. 1). According to configurations of the present invention, power consumption of the overvoltage protection circuit 240 may be minimized. This will be described in detail with descriptions of the DC converter 250 and the feedback control unit 260.

FIG. 5 is a block diagram exemplarily illustrating the switch unit 241 illustrated in FIG. 2. Referring to FIG. 5, the switch unit 241 includes a switch 241b and a switch controller 241a. The switch 241b electrically connects or blocks the reception unit 200 to or from the load 300. The switch controller 241a controls opening and closing of the switch 241b.

A voltage applied to the input terminal of the switch unit 241 (hereinafter, referred to as a node voltage) is detected by the switch controller 241a. For an embodiment, a reference voltage for determining whether the overvoltage is generated may be stored in the switch controller 241a. When the node voltage is larger than the reference voltage, the switch controller 241a turns off the switch 241b. If the switch 241b is turned off, the load 300 is electrically cut off from the reception unit 200. Accordingly, the load 300 is protected from the overvoltage. When the node voltage is smaller than the reference voltage (hereinafter, this state is referred to as a normal voltage state), the switch controller 241a turns on the switch 241b. If the switch 241b is turned on, the load 300 is electrically connected to the reception unit 200. Therefore, in the normal voltage state, power is supplied to the load 300 from the reception unit 200.

For an embodiment, the switch 241b may be configured with a metal oxide filed effect transistor (MOSFET). Herein, the switch controller 241a may turn on and off the switch 241b by controlling a gate voltage of the MOSFET.

According to the above-described configuration of the switch 241, when the overvoltage is generated, the switch is turned off to thereby block the current path to the load. As a result, the load is protected from the overvoltage.

FIG. 6 is a diagram exemplarily illustrating the DC converter illustrated in FIG. 1. Referring to FIG. 6, an output terminal of the DC converter 250 is connected to a load R_{L}.

An applied voltage Va and an applied current Ia are inputted to an input terminal of the DC converter 250. An output voltage Vo and an output current Io are outputted from an output terminal of the DC converter 250. The DC converter 250 serves to supply rated power for driving a load. Therefore, the DC converter 250 converts the applied voltage into a rated voltage of the load. Herein, the DC converter 250 supplies a constant voltage as the output voltage Vo.

Meanwhile, a supplied power Pa inputted to the input terminal, and a load power Po outputted from the output terminal are expressed as Equation (6).

Pₐ=vₐ×Iₐ

Pₒ=Vₒ×Iₒ (6)

if η=100%, Pₐ=Pₒ

Herein, Vo=Io×R_{L}, and if it is assumed that the DC converter 250 has an conversion efficiency of 100%, Pa=Po.

For instance, it is assumed that a load of an electronic device has rated voltage and power of about 5 V and about 10 W. In this case, power supplied to the DC converter 250 should also be about 10 W. For instance, when an applied voltage is about 10 V, a current applied to the DC converter 250 is about 1 Å. On the contrary, when the applied voltage is about 4 V, the current applied to the DC converter 250 is about 2.5 A. According to electric energy required by the load, the applied voltage and current may be changed.

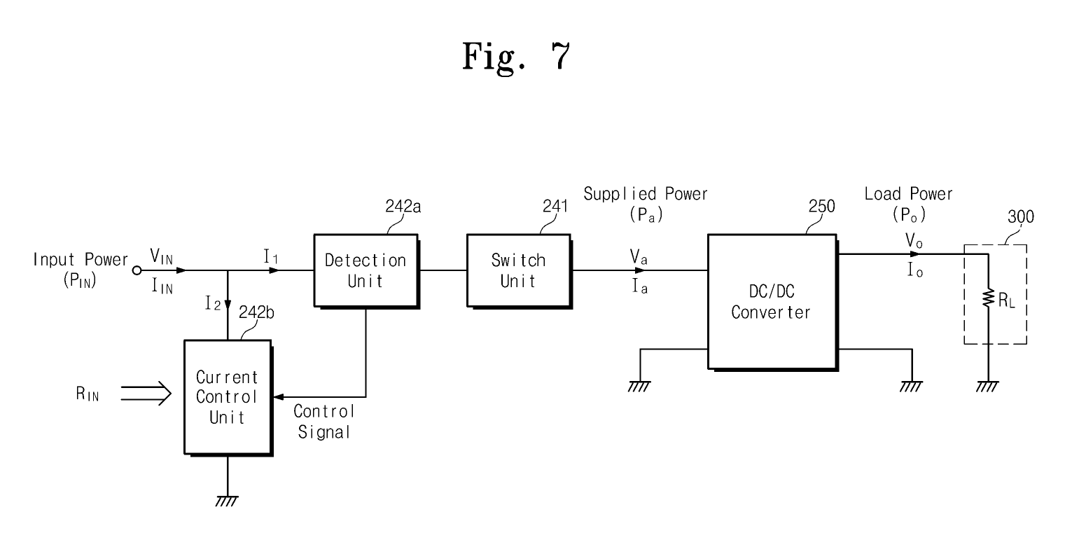

FIG. 7 is a diagram illustrating a power transmission device in which power consumption of an overvoltage protection circuit is reduced, according to an embodiment of the present invention. Referring to FIG. 7, the power transmission device according to the present embodiment includes a detection unit 242a, a current control unit 242b, a switch unit 241, and a DC converter 250. An output terminal of the DC converter 250 is connected to a load 300.

Detailed functions of the detection unit 242a, the current control unit 242b, the switch unit 241, and the DC converter 250 are the same as above. Hereinafter, it will be described how power consumption of the current control unit 242b is reduced according to the above-described configurations.

In FIG. 7, it is assumed that a voltage drop rarely occurs in the detection unit 242a and the switch unit 241. According to this assumption, input voltage V_{IN}≈applied voltage Vₐ, and first current I₁≈applied current Iₐ.

Herein, input power P_{IN} may be expressed as Equation (7).

$${P}_{IN} = {V}_{IN} \times {I}_{IN} = {V}_{IN} \times ( {I}_{1} + {I}_{2} ) = {V}_{IN} \times {I}_{1} + {V}_{IN} \times {I}_{2} \approx {V}_{a} \times {I}_{a} + {V}_{IN} \times {I}_{2} = {P}_{a} + {V}_{IN} \times {I}_{2} \qquad ( 7 )$$

Herein, the first term Pa is supplied power which is transferred to the load to be used for driving the load. The second term V_{IN}×I₂ is power consumed by the current control unit 242b, which is unnecessary power consumption during operations of the power transmission device.

According to the present invention, for reducing the unnecessary power consumption V_{IN}×I₂, power transmitted from the transmission unit 100 to the reception unit 200 is controlled. To this end, the input voltage V_{IN} or second current I₂ is outputted as a detection signal from the current control unit 242b (refer to FIG. 3). The feedback control unit 260 provides the outputted detection signal as a feedback signal to the transmission unit 100 (refer to FIG. 1). The transmission unit 100 refers to the feedback signal to control the power transmitted to the reception unit.

For reducing a value of the second term V_{IN}×I₂ of Equation (7), the transmission unit 100 reduces the power transmitted. Accordingly, the input power P_{IN} decreases. Meanwhile, as described above, the DC converter 250 supplies a constant voltage as the output voltage Vo. Therefore, if the load 300 is constant, the load power Po is constant. Referring to Equation (6), the applied power Pa is also constant due to the DC converter 250.

Therefore, for satisfying Equation (7), the second term V_{IN}×I₂ decreases as much as the left side (i.e., input power P_{IN}) decreases.

In detail, if the input power P_{IN} decreases, the input voltage V_{IN} and the input current I_{IN} decrease. Since the load power Po is constant, according to Equation (6), the first current I₁ increases (∵Va≈Y_{IN}, Ia≈I₁).

Meanwhile, as described above, the current control unit 242b controls the second current I₂ so that the equivalent resistance R_{IN} is constant. Referring to FIG. 5, the current control unit 242b reduces the second current I₂ to thereby offset the decrease of the input voltage V_{IN} and the increase of the first current F. Since both of the input voltage V_{IN} and the second current I₂ decrease, the power consumption V_{IN}×I₂ of the current control unit 242b also decreases.

The transmission unit 100 may refer to the feedback signal to reduce the transmitted power until the second current I₂ approximates to 0. When the second current I₂ is close to 0, the unnecessary power consumption V_{IN}×I₂ is also close to 0. That is, the second term of the right side of Equation (7) is eliminated (i.e., P_{IN}≈Pa=Po).

For an embodiment, it may be considered that the load 300 is changed.

Firstly, when the load 300 increases, the load power Po decreases (i.e., Po=Vo²/R_{L}). Referring to FIG. 7, the decrement of the load power Po is expressed as the increment of the second term V_{IN}×I₂, and the second current I₂ increases. For reducing unnecessary power consumption, the transmission unit 100 reduces the transmitted power with reference to the increased second current I₂. Through the same processes as the above processes described with reference to FIG. 7, the unnecessary power consumption may be reduced.

Next, when the load 300 decreases, the load power Po increases. In this case, if the second current I2 is 0, power needed for the load is not sufficiently supplied because Po>P_{IN}. Therefore, in the power transmission device according to the present embodiment, the second current I2 is controlled so as to maintain a reference current (e.g., about 100 mA).

When the load power Po increases in the power transmission device, the first current I₁ increases to increase the supplied power Pa, and accordingly, the second current I₂ decreases (refer to Equations (5) and (7)). The decreased second current I₂ is transferred as the feedback signal to the transmission unit 100, and the transmission unit 100 increases the transmitted power with reference to the feedback signal. Therefore, the second current I₂ increases when the input power P_{IN} increases. The transmission unit 100 continuously control the transmitted power so that the second current I₂ is maintained as a constant reference current (e.g., about 100 mA).

As a result, when the load power Po increases due to the change of the load, needed power is supplied from the power consumed by the current control unit 242b. On the contrary, when the load power Po decreases due to the change of the load, surplus power is consumed by the current control unit 242b. The power consumed by the current control unit 242b may function as a kind of reserve power. However, during a normal operation, the power consumption of the current control unit 242b is unnecessary. Therefore, the second current I₂ needs to be limited to a small value so that the unnecessary power consumption is not large.

According to the above-described configuration of the present invention, the unnecessary power consumption V_{IN}×I₂ generated while operating the power transmission device 1000 is minimized. Further, the supplied power Pa may be actively controlled according to the change of the load 300.

For an embodiment, the reception unit 200 of the power transmission device 1000 may further include the matching circuit 220 and the rectifying unit 230 in front of the overvoltage protection circuit 240.

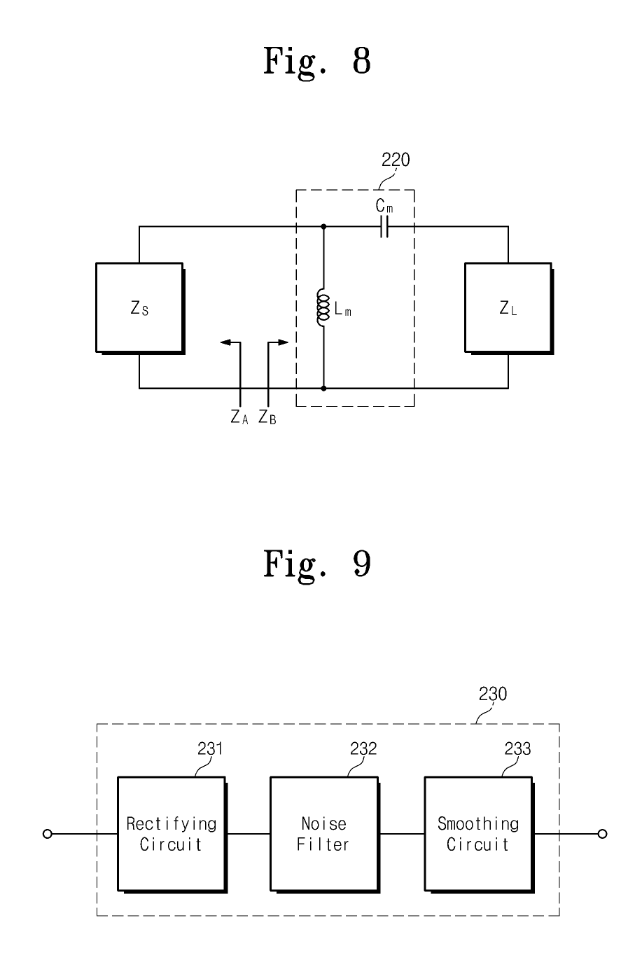

FIG. 8 is a diagram exemplarily illustrating the matching circuit 220 of FIG. 1. The matching circuit 220 matches impedance between the transmission unit 100 and the reception unit 200. The matching circuit 220 may be configured in various forms. For an embodiment, the matching circuit 220 may be constituted of a single coil and a single capacitor. If the impedance matching is not achieved, reflection of power occurs in the reception unit 200, and accordingly, power is not maximally transferred.

Generally, for the impedance matching, both impedances Z_{A} and Z_{B} viewed from a certain contact point should be complex conjugates of each other. By acquiring source impedance Z_{S} and load impedance Z_{L}, and by selecting values of Lm and Cm corresponding thereto (hereinafter, referred to as an impedance matching point), impedances may be matched. Detailed configurations and design methods of the matching circuit 220 are well known to those skilled in the art, and thus, detailed descriptions of the matching circuit 220 are omitted.

FIG. 9 is a block diagram exemplarily illustrating the rectifying unit 230 illustrated in FIG. 1. Referring to FIG. 9, the rectifying unit 230 includes a rectifying circuit 231, a noise filter 232, and a smoothing circuit 233. The rectifying circuit 231 rectifies alternating current power outputted from the matching circuit 220 to generate direct current power. The noise filter 232 eliminates noises included in the rectified direct current power. The smoothing circuit 233 eliminates an alternating current component included in the rectified direct current power.

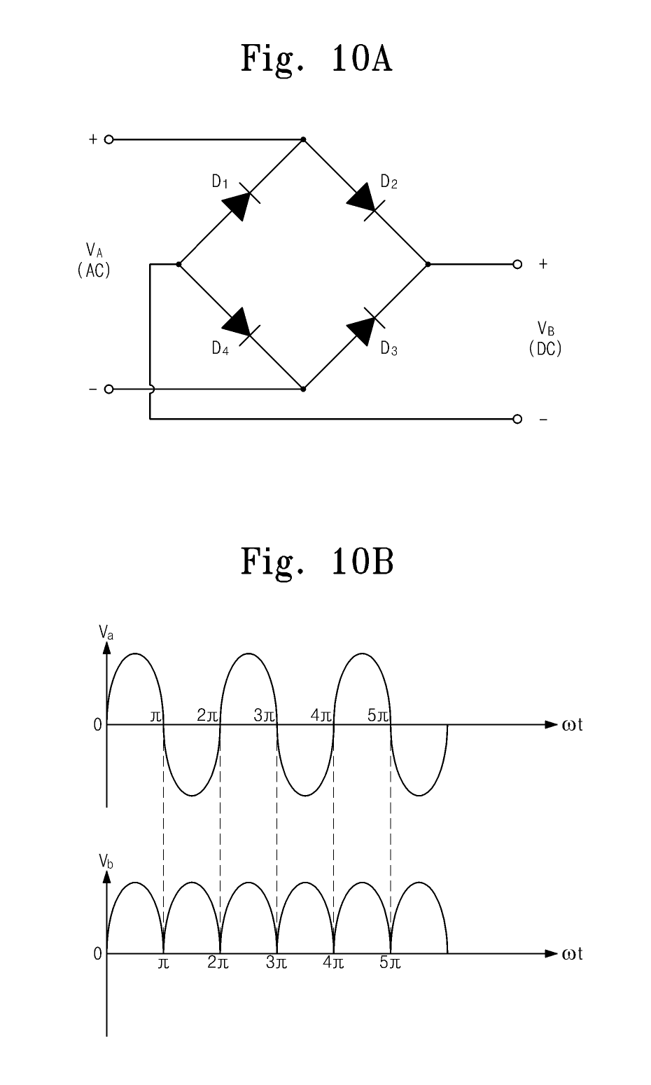

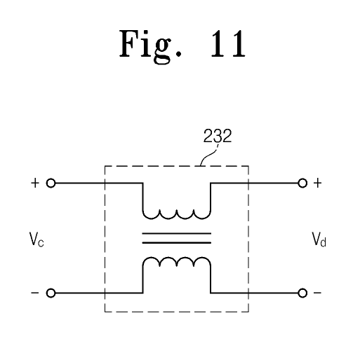

FIG. 10A is a circuit diagram exemplarily illustrating the rectifying circuit 231 illustrated in FIG. 9. FIG. 10A shows a full-wave rectifying circuit which is a kind of a rectifying circuit. Referring to FIG. 10A, the rectifying circuit 231 receives an alternating current voltage V_{A} as an input, and provides a direct current voltage V_{B} as an output.

When the inputted alternating current voltage V_{A} is positive, diodes D2 and D4 are turned on, and diodes D1 and D3 are turned off. Herein, the outputted direct current voltage V_{B} is positive. When the inputted alternating current voltage V_{A} is negative, the diodes D1 and D3 are turned on, and the diodes D2 and D4 are turned off. Herein, the outputted direct current voltage V_{B} is still positive.

FIG. 10B illustrates waveforms of the inputted alternating current voltage V_{A} and the outputted direct current voltage V_{B} of FIG. 10A. Referring to FIG. 10B, regardless of the change of a sign of the alternating current voltage V_{A}, the direct current voltage V_{B} always has a positive value.

Meanwhile, the rectifying circuit 231 illustrated in FIG. 10A is just an example, and thus may be variously configured in other forms. Detailed design methods of the rectifying circuit 231 are well known to those skilled in the art. Therefore, detailed descriptions of the rectifying circuit 231 are omitted.

FIG. 11 is a schematic diagram exemplarily illustrating the noise filter 232. The noise filter 232 eliminates noises included in a voltage or current. For an embodiment, two coils respectively connected to two terminals of an input V_{c} may be wound on a single core in opposite directions. According to this configuration, since lines of magnetic force of the terminals have opposite phases, noises in the terminals offset each other. Therefore, a noise-eliminated voltage is provided as an output V_{d} of the noise filter 232. According to a kind of the noise filter 232, a capacitor connected in parallel to an input terminal or output terminal may be included.

The noise filter 232 illustrated in FIG. 11 is just an example, and may be configured in various other forms. Detailed configurations and design methods of the noise filter 232 well known to those skilled in the art, and thus, detailed descriptions of the noise filter 232 are omitted.

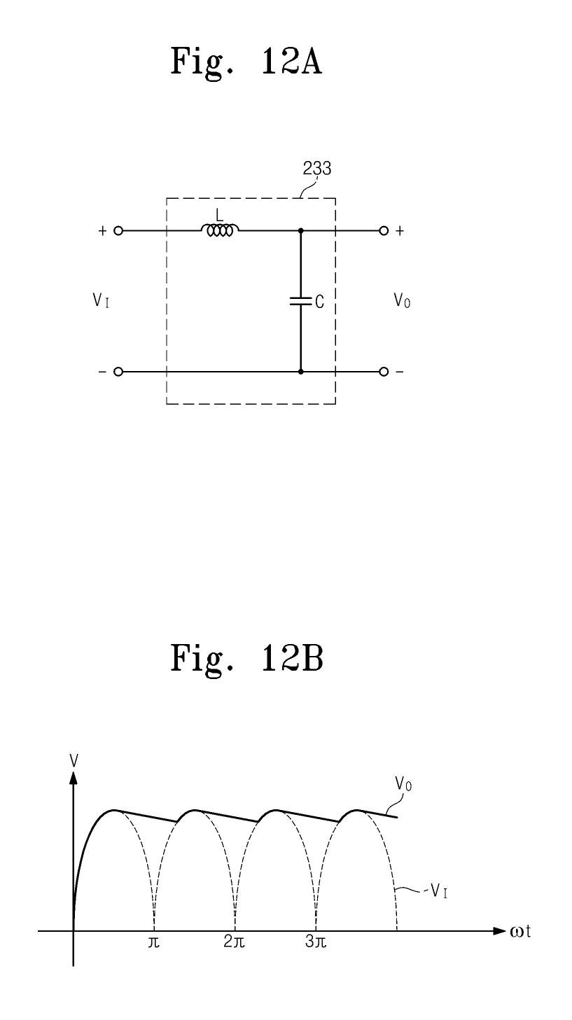

FIG. 12A is a circuit diagram exemplarily illustrating the smoothing circuit 233 illustrated in FIG. 9. Referring to FIG. 12A, the smoothing circuit 233 eliminates an alternating current component included in a rectified voltage.

For instance, the smoothing circuit 233 may be constituted of a single coil and a single capacitor. Generally, a capacitor cuts off a direct current component and passes an alternating current component. On the contrary, a coil passes a direct current component and cuts off an alternating current component. Referring to FIG. 12A, a coil L connected between an input V_{I} and an output V_{O} prevents an alternating current component from being outputted. Herein, the coil L has a high inductance. A capacitor C connected in parallel between an output and a ground induces an alternating current component to the ground to thereby further eliminate a remaining alternating current component.

FIG. 12B illustrates waveforms of the input V_{I} (shown in dotted line) and the output V_{O} (shown in continuous line) of the smoothing circuit 233. It is shown that ripples of the output V_{O} become smaller than those of the input V_{I}. Detailed design methods of the smoothing circuit 233 are well known to those skilled in the art, and thus, detailed descriptions of the design methods are omitted.

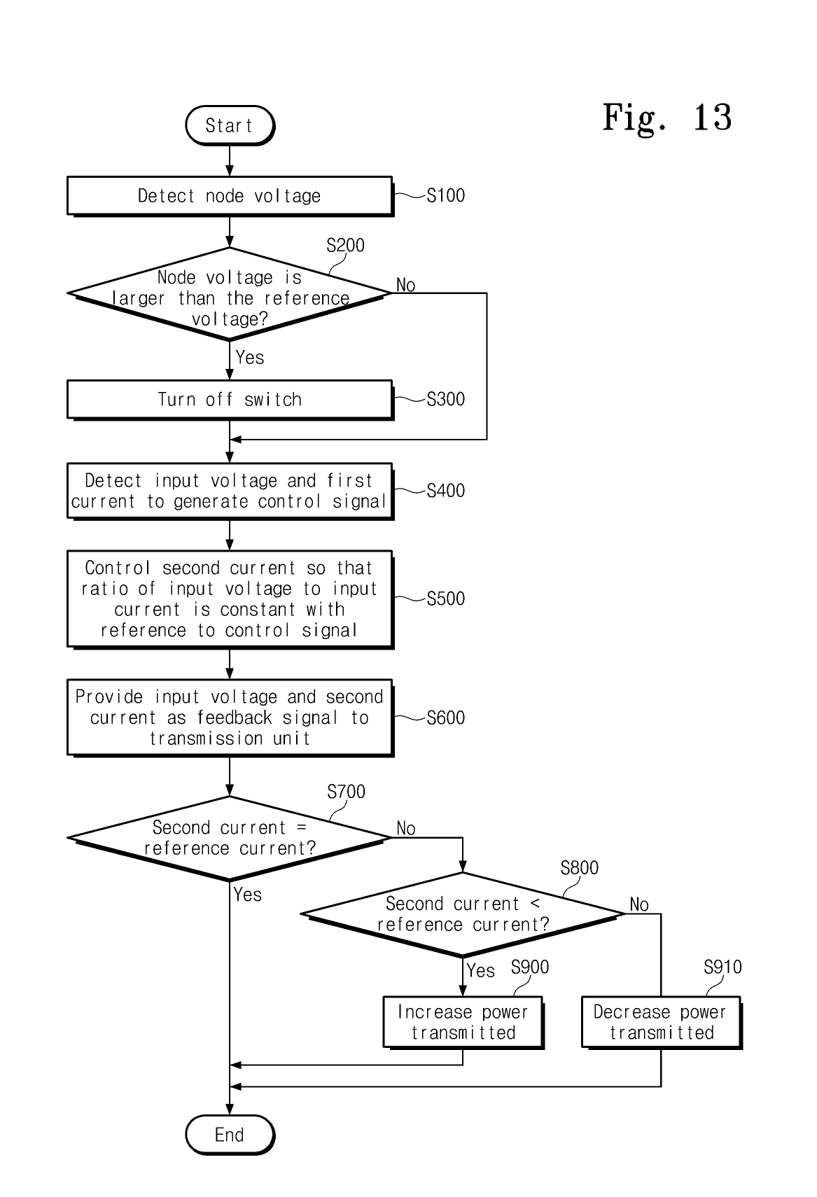

FIG. 13 is a flowchart illustrating a control method of the power transmission device 1000 according to an embodiment of the present invention. Referring to FIG. 13, when a voltage applied to the overvoltage protection circuit 240, an overvoltage protection process is started.

In operation S100, the switch unit 241 detects a node voltage. In detail, the node voltage is detected by the switch controller 241a included in the switch unit 241. The switch controller 241a controls opening and closing of the switch 241b. In a normal voltage state, the switch controller 241a controls the switch 241b to be closed.

In operation S200, the switch controller 241a determines whether the node voltage is larger than a pre-programmed reference voltage.

In operation S300, when the node voltage is larger than the reference voltage, the switch controller 241a opens the switch 241b. When the switch 241b is opened, the load 300 is electrically cut off from the reception unit 200. When the transferred voltage is not larger than the reference voltage, the switch 241b remains closed.

In operation S400, the detection unit 242a detects a first current and an input voltage to provide a control signal to the current control unit 242b. Herein, the input voltage is loaded on an input terminal of the current distribution unit 242. The first current flows from the input terminal of the current distribution unit 242 to an output terminal thereof. For an embodiment, the detection unit 242a may not detect the input voltage. In this case, the input voltage is detected by the current control unit 242b.

In operation S500, the current control unit 242b refers to the control signal to control a second current. The second current flows from the input terminal of the current distribution unit 242 to a ground. The second current controls a ratio of the input voltage to an input current to be constant. Herein, the input current means a total current flowing into the input terminal of the current distribution unit 242. For an embodiment, the input current is equal to a sum of the first and second current. In this case, the second current is controlled to be proportional to the input voltage and reversely proportional to the first current (refer to Equation (5)). This operation has been described in the descriptions of the embodiment of the overvoltage protection circuit 240.

In operation S600, the current control unit 242b provides the input voltage and the second current as detection signals to the feedback control unit 260. The feedback control unit 260 provides the detection signals as feedback signals to the transmission unit 100.

In operations S700 and S800, the transmission unit 100 compares the second current and a reference current with reference to the feedback signals.

In operations S900 and S910, the transmission unit 100 increases power transmitted when the second current is smaller than the reference current. When the second current is larger than the reference current, the transmission unit 100 decreases the power transmitted. When the power transmitted increases or decreases, the second current is also increases or decreases. The transmission unit 100 controls the power transmitted until the second current becomes equal to the reference current.

According to the above-described overvoltage protection method, the load 300 can be protected from the overvoltage. Also, power consumption of the overvoltage protection circuit 240 can be reduced. Further, even when the overvoltage is generated or the load is changed, the receiving-end impedance can be kept constant, thereby improving transmission efficiency.

According to the above-described embodiments of the present invention, a power transmission device with low power consumption is provided. Further, an internal circuit of the power transmission device is protected from the overvoltage. Further, impedance matching characteristics of the power transmission device are improved.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An overvoltage protection circuit in a power transmission device, comprising:
a detection unit configured to detect a first current flowing from an input terminal to an output terminal and an input voltage applied to the input terminal to generate a control signal; and
a current control unit configured to control a second current flowing from the input terminal to a ground in response to the control signal so that a ratio of the input voltage to an input current inputted through the input terminal is kept constant.

2. The overvoltage protection circuit of claim 1, wherein the input current is a sum of the first and second currents.

3. The overvoltage protection circuit of claim 2, wherein the current control unit is located between the input terminal and the ground.

4. The overvoltage protection circuit of claim 3, wherein the current control unit comprises a variable resistor which connects the input terminal and the ground.

5. A power transmission device comprising:
a reception unit comprising an overvoltage protection circuit; and
a transmission unit configured to wirelessly transmit power to the reception unit,
wherein the transmission unit controls power consumption of the overvoltage protection circuit by controlling intensity of the power transmitted with reference to a feedback signal provided from the reception unit.

6. The power transmission device of claim 5, wherein the overvoltage protection circuit comprises:
a detection unit configured to detect a first current flowing from an input terminal to an output terminal and an input voltage applied to the input terminal to generate a control signal; and
a current control unit configured to control a second current flowing from the input terminal to a ground in response to the control signal so that a ratio of the input voltage to an input current inputted through the input terminal is kept constant.

7. The power transmission device of claim 6, wherein the input current is a sum of the first and second currents.

8. The power transmission device of claim 8, wherein the reception unit comprises:
a direct current (DC) converter configured to transform power outputted from the overvoltage protection circuit and provide the transformed power to a load; and
a feedback control unit configured to receive a detection signal from the overvoltage protection circuit, and provide the detection signal as the feedback signal.

9. The power transmission device of claim 8, wherein the detection signal comprises a signal which indicates a value of the second current.

10. The power transmission device of claim 9, wherein the transmission unit controls power consumption of the overvoltage protection circuit by decreasing or increasing the intensity of the power transmitted if the value of the second current is larger than or smaller than a value of a reference current.

11. The power transmission device of claim 10, wherein the overvoltage protection circuit further comprises a switch unit configured to electrically cut off the DC converter from the overvoltage protection circuit.

12. The power transmission device of claim 11, wherein the switch unit comprises:
a switch located between the detection unit and the DC converter; and
a switch controller configured to control opening and closing of the switch.

13. The power transmission device of claim 12, wherein the switch controller detects a node voltage between the detection unit and the switch to turn off or turn on the switch if the node voltage is larger than or smaller than a reference voltage.

14. The power transmission device of claim 13, wherein the reception unit further comprises a rectifying unit which is located in front of the overvoltage protection circuit and rectifies an alternating current power to a direct current power.

15. The power transmission device of claim 14, wherein the reception unit further comprises a matching circuit which is located in front of the rectifying unit and matches impedances between the transmission unit and the reception unit.

16. A method for controlling a power transmission device comprising a reception unit provided with an overvoltage protection circuit, comprising:
detecting a first current which flows from an input terminal of the overvoltage protection circuit to an output terminal thereof;
detecting an input voltage applied to the input terminal; and
controlling a second current which flows from the input terminal to a ground with reference to the first current and the input voltage so that a ratio of the input voltage to an input current inputted through the input terminal is kept constant.

17. The method of claim 16, further comprising:
providing a value of the input voltage or second current as a feedback signal to a transmission unit; and
controlling intensity of power which is wirelessly transmitted from the transmission unit to the reception unit with reference to the feedback signal.

18. The method of claim 16, wherein the controlling of the intensity of the power comprises decreasing or increasing the intensity of the power transmitted if the second current is larger than or smaller than a reference current.
